(19) United States
(12) Patent Application Publication
(10) Pub. No.: US 2012/0137159 A1
(43) Pub. Date: May 31, 2012

(54) MONITORING SYSTEM AND METHOD OF POWER SEQUENCE SIGNAL

(75) Inventors: Chih-Jen Chin, Taipei (TW); Quan-Jie Zheng, Tianjin (CN); Chih-Feng Chen, Taipei (TW)

(73) Assignee: INVENTEC CORPORATION, Taipei (TW)

(21) Appl. No.: 13/070,976

(22) Filed: Mar. 24, 2011

(30) Foreign Application Priority Data
Nov. 30, 2010 (CN) 201010589582.3

(51) Int. Cl. G06F 1/26

(52) U.S. Cl. 713/340

(57) ABSTRACT

A monitoring system and method of the power sequence signals are presented, so as to monitor a power sequence signals transmitted via the peripheral devices of a motherboard in operation process. The monitoring system includes a power supply unit and a Complex Programmable Logic Device (CPLD). The monitoring method includes activating the motherboard, and driving the CPLD to select any one of the peripheral devices in sequence being electrified; controlling, by the CPLD, operation powers of the peripheral devices through a General Purpose Input/Output (GPIO) pin, and recording the power sequence signals of the peripheral devices under different operation powers in a data register; and outputting, by the CPLD, the power sequence signals of the peripheral devices.

### CROSS-REFERENCE TO RELATED APPLICATIONS

This non-provisional application claims priority under 35 U.S.C. §119(a) on Patent Application No(s). 201010589582.3 filed in China, P.R.C. on Nov. 30, 2010, the entire contents of which are hereby incorporated by reference.

### BACKGROUND OF THE INVENTION

1. Field of Invention

The present invention relates to a monitoring system, and more particularly to a monitoring system of the power sequence signals of peripheral devices of a motherboard in operation process.

2. Related Art

In the prior art, the operation of a motherboard is detected by a baseboard management controller. FIG. 1 is a schematic view of architecture of peripheral devices of a motherboard in the prior art. In general, normal operation of a motherboard 100 requires normal power supply from a power supply unit. If the power supply from the power supply unit is unstable, damage of the peripheral devices in the motherboard 100 may be caused.

A Complex Programmable Logic Device (CPLD) is disposed in the motherboard 100 in the prior art. However, the motherboard 100 in the prior art is solely used to control the electrification of the power supply unit for the peripheral devices (for example, a fan 120, a central processing unit (CPU) 130, or a platform controller hub (PCH) 140). In other words, the CPLD 110 is only responsible for the power switch of the peripheral devices, and does not monitor the powers of the peripheral devices. Therefore, in case of abnormal operation of the peripheral devices caused by the unstable power supplied by the power supply unit, the CPLD 110 cannot know which peripheral device has the power supply problem. Accordingly, as far as a development manufacturer is concerned, a correct solution cannot be provided if the error source cannot be effectively detected.

### SUMMARY OF THE INVENTION

In view of the problem above, the present invention is a monitoring system of the power sequence signals, so as to monitor power sequence signals transmitted through peripheral devices of a motherboard in operation.

The monitoring system of the power sequence signals disclosed in the present invention comprises a power supply unit and a CPLD. The power supply unit is used to provide operation powers to the motherboard and the peripheral devices; and the CPLD is electrically connected to the power supply unit and the peripheral devices and further comprises at least one data register; in which the CPLD controls operation powers of the peripheral devices through a General Purpose Input/Output (GPIO) pin, and records the power sequence signals of the peripheral devices by the data register.

The present invention is further a monitoring method of a power sequence signals, so as to monitor power sequence signals transmitted through peripheral devices of a motherboard in operation.

The monitoring method of the power sequence signals disclosed in the present invention comprises: activating the motherboard, and driving the CPLD to select any one of the peripheral devices in sequence for being electrified; controlling, by the CPLD, operation powers of the peripheral devices through the GPIO pin, and recording the power sequence signals of the peripheral devices under different operation powers in a data register; and outputting, by the CPLD, the power sequence signals of the peripheral devices.

The present invention provides a monitoring system and method of the power sequence signals. According to the present invention, the CPLD controls the operation powers of the peripheral devices provided by the power supply unit and records the power sequence signals of the peripheral devices respectively through the GPIO pin and the data register. The CPLD outputs the power sequence signals through the communication interface, so as to enable a user to conveniently observe operation statuses of the peripheral devices.

### BRIEF DESCRIPTION OF THE DRAWINGS

The present invention will become more fully understood from the detailed description given herein below for illustration only, and thus are not limitative of the present invention, and wherein:

FIG. 1 is a schematic view of architecture of peripheral devices of a motherboard in the prior art;

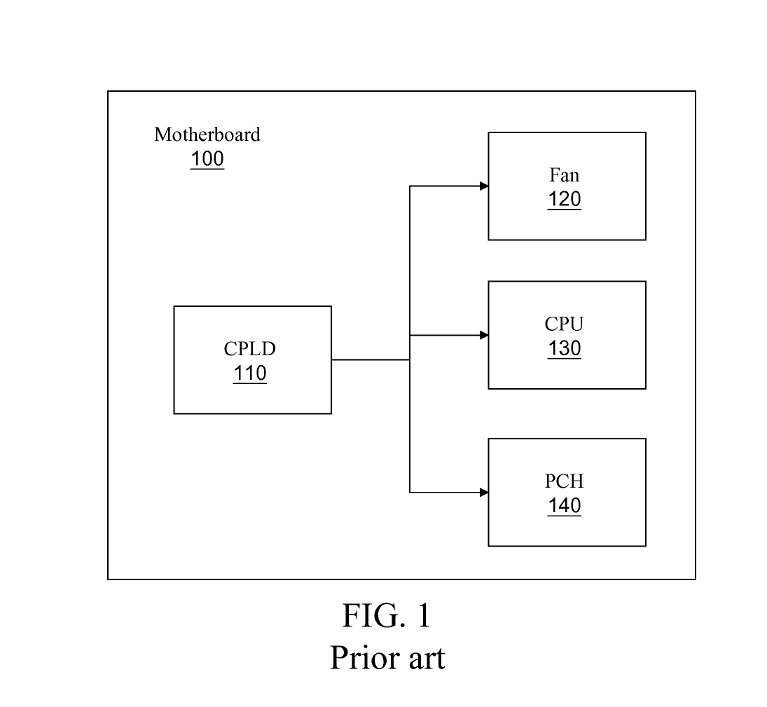

FIG. 2 is a schematic view of architecture of the present invention; and

FIG. 3 is a schematic view of an operation flow of the present invention.

### DETAILED DESCRIPTION OF THE INVENTION

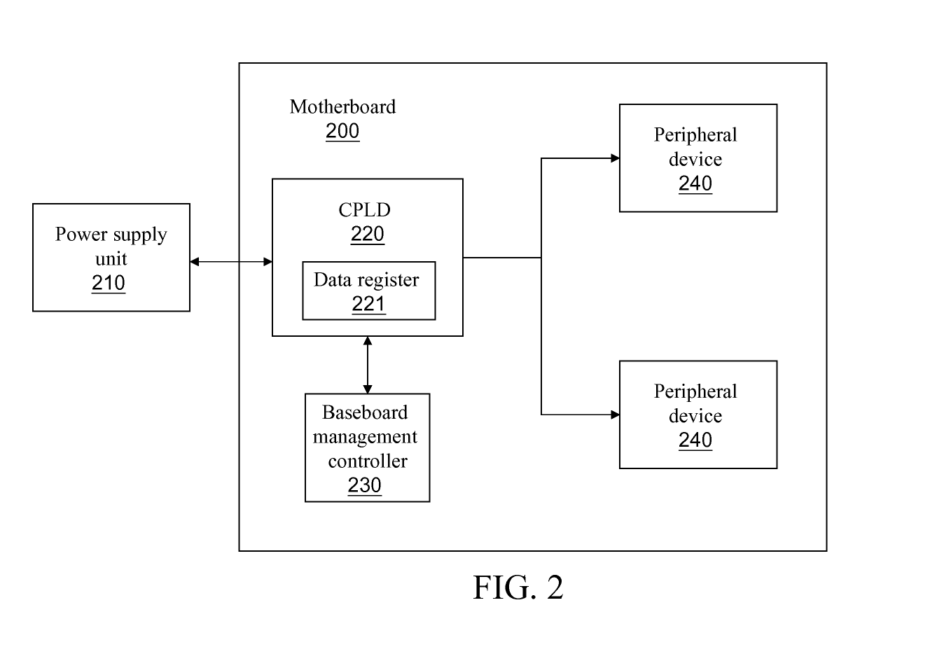

FIG. 2 is a schematic view of architecture of the present invention. A monitoring system of power sequence signals of the present invention comprises a power supply unit 210, a CPLD 220, and a baseboard management controller 230(BMC). The power supply unit 210 is used to provide operation powers to a motherboard 200 and peripheral devices 240. The peripheral devices 240 comprise a south bridge chip set, a peripheral component interconnect express (PCI-E), an Intelligent Platform Management Bus (IPMB), a dual in-line memory module (DIMM), a serial port, and a network connector or a fan.

The CPLD 220 is electrically connected to the power supply unit 210 and the peripheral devices 240. The CPLD 220 is connected to the power supply unit 210 through a Power management Bus (PMBus). The CPLD 220 further comprises at least one data register 221. The CPLD 220 controls operation powers of the peripheral devices 240 through a GPIO pin, and records the power sequence signals of the peripheral devices 240 by the data register 221. The power sequence signals may be a logic level value, a duration, a Power-Good signal and the combination thereof.

The baseboard management controller 230 is electrically connected to the power supply unit 210 trough the PMBus. The baseboard management controller 230 further comprises a communication interface. The CPLD 220 outputs the power sequence signals of the peripheral devices 240 through the communication interface. The communication interface may be, but not limited to, a network interface (for example RJ-45). The CPLD 220 may output the power sequence signals through the PCI-E or the IPMB.

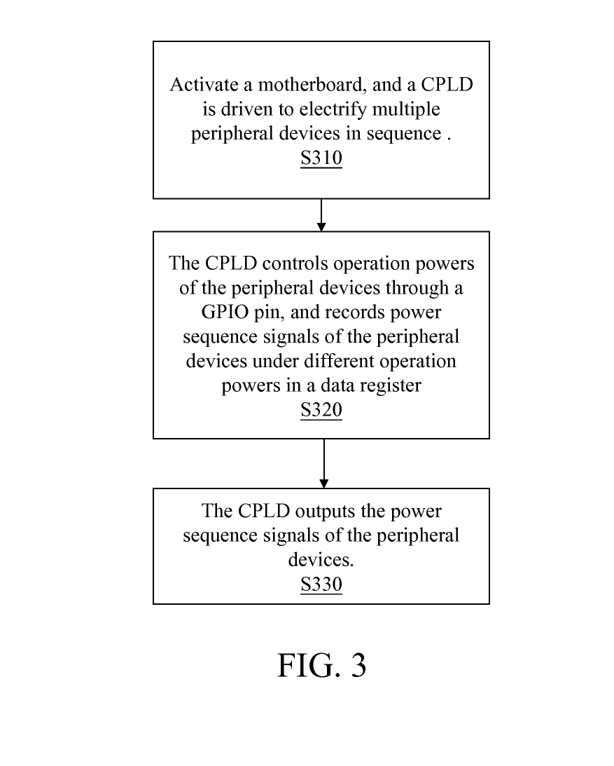

Operation relations of the devices in the present invention are clearly illustrated with reference to FIG. 3, and FIG. 3 is a schematic view of an operation flow of the present invention. The operation flow of the present invention comprises the following steps.

In Step S310, a motherboard is activated, and a CPLD is driven to electrify multiple peripheral devices in sequence.

In Step S320, the CPLD controls operation powers of the peripheral devices through GPIO pins, and records power sequence signals of the peripheral devices under different operation powers in a data register.

In Step S330, the CPLD outputs the power sequence signals of the peripheral devices.

At first, in activation of the motherboard 200, a program for monitoring the peripheral devices 240 of the motherboard 200 is executed in the CPLD 220. The CPLD 220 sequentially performs the electrification and adjustment of supply power on the peripheral devices 240 according to a monitoring sequence of the peripheral devices 240 recorded by the monitoring program.

As each of the peripheral devices 240 may work at different voltages, each voltage respectively has a corresponding Power-Good signal. The CPLD 220 may control related circuits of the peripheral devices 240 through the GPIO pin according to a timer, so as to electrify the peripheral devices 240 in sequence. The CPLD 220 acquires status information of the peripheral devices 240 from the Power-Good signal at the same time.

Therefore, when the CPLD 220 adjusts the supply powers of the peripheral devices 240, the data register 221 records the power sequence signals of the peripheral devices 240, such as, logic level value, duration, and Power-Good signal.

The present invention provides a monitoring system and method of the power sequence signals. According to the present invention, the CPLD 220 controls the operation powers of the peripheral devices 240 provided by the power supply unit and records the power sequence signals of the peripheral devices respectively through the GPIO pin and the data register 221. Then, the CPLD 220 outputs the power sequence signals through the communication interface, so as to enable a user to conveniently observe operation statuses of the peripheral devices 240.

What is claimed is:

1. A monitoring system of the power sequence signals, for monitoring power sequence signals transmitted through peripheral devices of a motherboard in operation, comprising:
a power supply unit, for providing operation powers to the motherboard and the peripheral devices; and
a Complex Programmable Logic Device (CPLD), electrically connected to the power supply unit and the peripheral devices, and further comprising at least one data register, wherein the CPLD controls operation powers of the peripheral devices through a General Purpose Input/Output (GPIO) pins, and records the power sequence signals of the peripheral devices by the data register.

2. The monitoring system of the power sequence signals according to claim 1, wherein the peripheral devices comprise a south bridge chip set, a peripheral component interconnect express (PCI-E), an Intelligent Platform Management Bus (IPMB), a dual in-line memory module (DIMM), a serial port, a network connector, or a fan.

3. The monitoring system of the power sequence signals according to claim 1, wherein the power sequence signals comprise a logic level value, a duration, and a Power-Good signal.

4. The monitoring system of the power sequence signals according to claim 1, further comprising a baseboard management controller, electrically connected to the power supply unit, wherein the baseboard management controller further comprises a communication interface, and the CPLD outputs the power sequence signals of the peripheral devices through the communication interface.

5. The monitoring system of the power sequence signals according to claim 4, wherein the baseboard management controller further comprises an Inter-Integrated Circuit (I2C), and transfers the power sequence signals through the CPLD.

6. A monitoring method of the power sequence signals, for monitoring power sequence signals transmitted through peripheral devices of a motherboard in operation, comprising:
activating the motherboard, and driving a Complex Programmable Logic Device (CPLD) to select any one of the peripheral devices in sequence for being electrified;
controlling, by the CPLD, operation powers of the peripheral devices through General Purpose Input/Output (GPIO) pins, and recording the power sequence signals of the peripheral devices under different operation powers in a data register; and
outputting, by the CPLD, the power sequence signals of the peripheral devices.

7. The monitoring method of the power sequence signals according to claim 6, wherein the power sequence signals may be a logic level value, a duration, a Power-Good signal and the combination thereof.

8. The monitoring method of the power sequence signals according to claim 6, wherein a baseboard management controller is further comprised, the baseboard management controller is electrically connected to a power supply unit and further comprises a communication interface, and the CPLD outputs the power sequence signals of the peripheral devices through the communication interface.
